(19) United States
(12) Patent Application Publication
(10) Pub. No.: US 2026/0289985 A1
(43) Pub. Date: Sep. 24, 2026

(54) ITERATIVELY TRAINING A MACHINE LEARNING MODEL

(71) Applicant: TurbineOne, Inc., San Francisco, CA (US)

(72) Inventors: Charles R. Barker, JR., Orlando, FL (US); Keith Joseph Goldberg, Winter Park, FL (US); Joshua Harrison, Boulder, CO (US); Sandeep Mittal, Garner, NC (US); Daniel Hebb, San Diego, CA (US)

(21) Appl. No.: 19/087,162

(22) Filed: Mar. 21, 2025

(51) Int. Cl. G06V 10/778; G06V 10/764; G06V 10/774

(52) U.S. Cl. CPC G06V 10/7788; G06V 10/764; G06V 10/7753

(57) ABSTRACT

A computing system can detect objects, including potential threats, in the environment using a machine learning model. The computing system trains an object detection model (ODM) from a plurality of training images including a set of labeled training images. The computing system can receive a set of unlabeled training images including environmental image data (e.g., from an image sensor) and apply one or more unlabeled images to the object detection model to generate a first output. The computing system receives user feedback indicating accuracy of the first output, such as confirmation or a user-provided object label. The computing system can update the set of labeled training images by labeling the one or more unlabeled images according to the user feedback. The computing system can then selectively re-train the object detection model from the updated set of labeled training images when certain criteria are met.

### TECHNICAL FIELD

The present disclosure relates to machine learning-driven object detection. In particular, the disclosure relates to a computing system for training and iteratively re-training an object detection model responsive to user feedback.

### BACKGROUND

Machine learning can enable automated object detection using object detection models trained on sample media, including images and video frames. However, machine learning models may not be reliable (e.g., as a human) in accurately identifying security threats. To help remedy this inaccuracy, machine learning models can be re-trained to improve accuracy.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates a block diagram of a system environment in which a computing system operates, in accordance with one embodiment.

FIG. 2 depicts a block diagram of the computing system of FIG. 1, in accordance with one embodiment.

FIG. 3 shows a block diagram of a process for re-training an object detection model of the computing system of FIG. 1, in accordance with one embodiment.

FIG. 4A depicts a graphical user interface that includes notifications generated by the computing system of FIG. 1, in accordance with one embodiment.

FIG. 4B depicts an updated graphical user interface after a user has interacted with an alert notification of the graphical user interface of FIG. 4A, in accordance with one embodiment.

FIG. 4C depicts another graphical user interface that includes notifications generated by the computing system of FIG. 1, in accordance with one embodiment.

FIG. 4D depicts an updated graphical user interface after a user has interacted with an alert notification of the graphical user interface of FIG. 4C, in accordance with one embodiment.

FIG. 5A depicts a flowchart of a process for re-training machine learning models of the computing system of FIG. 1, in accordance with one embodiment.

FIG. 5B depicts a flowchart of a process for re-training an object detection model of the computing system of FIG. 1, in accordance with one embodiment.

FIG. 5C depicts a flowchart of a process for modifying the re-training process of FIG. 5B.

FIG. 6 is a block diagram illustrating components of an example machine able to read instructions from a machine-readable medium and execute them in a processor (or controller).

### DETAILED DESCRIPTION

The Figures (FIGS.) and the following description relate to embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Re-training a machine learning model such as an object detection model uses large volumes of annotated (e.g., labeled) sample media to improve the model. For a human operator, manually labeling objects depicted in each frame of the sample media is a time-consuming and tedious task. Moreover, conventional systems for training a machine learning model do not provide feedback as to the effect of newly labeled sample media on the behavior of the object detection model, making it difficult to gauge whether a user's annotations are actually improving the model. Thus, providing enough useful feedback to train or re-train an object detection model while achieving a desired accuracy (e.g., for detecting real-time security threats) is challenging because of the large amount of time and effort required to prepare the training media.

A computing system can detect objects, including potential threats, in the environment using a machine learning model. The computing system trains an (e.g., initial or rudimentary) object detection model (ODM) from a set of training images including a set of labeled training images. The computing system can receive a set of unlabeled training images including environmental image data (e.g., from an image sensor) and apply one or more unlabeled images to the object detection model to generate a first output. The computing system receives user feedback indicating accuracy of the output, such as confirmation or a user-provided object label. The computing system can update the set of labeled training images by labeling the one or more unlabeled images according to the user feedback. Accordingly, the computing system can aid the user in rapidly applying object labels generated by the object detection model to the one or more unlabeled images, where the user can revise or correct the generated labels as desired (e.g., via a user interface) to quickly grow the labeled training image set. The computing system can then selectively re-train the object detection model from the updated set of labeled training images when certain criteria are met. The computing system can provide (e.g., by a graphical user interface) examples of a re-trained model output to the user periodically (e.g., after subsequent re-training of the object detection model), demonstrating the effect of past user feedback on the accuracy of the object detection model.

Over multiple iterations of receiving unlabeled training images, generating object labels, receiving user feedback to label the unlabeled training images, and re-training the object detection model, the set of training images and detection accuracy of the object detection model can continue to improve.

In an embodiment, a non-transitory computer-readable storage medium includes stored instructions, the instructions, when executed by a computing system, cause the computing system to perform operations including receiving a plurality of training images, the training images including a set of labeled training images and a set of unlabeled training images, wherein labels of the labeled training images are received from a client device of a user, training an object detection model using the set of labeled training images, applying one or more images of the set of unlabeled training images to the object detection model to generate a first output of the object detection model, transmitting, to the client device, the first output of the object detection model, receiving, from the client device, user feedback indicating accuracy of the first output of the object detection model, updating the set of labeled training images by labeling one or more images of the set of unlabeled training images according to the user feedback, and re-training the object detection model using the updated set of labeled training images.

In an embodiment, re-training the object detection model using the updated set of labeled training images includes re-training the object detection model responsive to the user feedback including a threshold number of user-provided object labels.

In an embodiment, updating the set of labeled training images by labeling one or more images of the set of unlabeled training images according to the user feedback includes labeling one or more images of the set of unlabeled training images with user-provided object labels.

In an embodiment, updating the set of labeled training images by labeling one or more images of the set of unlabeled training images according to the user feedback includes labeling one or more images of the set of unlabeled training images with the first output of the object detection model responsive to an indication by the user that the first output is correct.

In an embodiment, the instructions further include instructions that, when executed by the computing system, cause the computing system to perform operations including applying one or more additional images of the set of unlabeled training images to the re-trained object detection model to generate a second output of the re-trained object detection model, transmitting, to the client device, the second output of the re-trained object detection model, receiving, from the client device, user feedback indicating accuracy of the second output of the re-trained object detection model, updating the set of labeled training images by labeling the one or more additional images of the set of unlabeled training images according to the user feedback, and re-training the re-trained object detection model using the updated set of labeled training images.

In an embodiment, the instructions further include instructions that, when executed by the computing system, cause the computing system to perform operations including applying a first sample image of a sample image set to the object detection model to generate a third output of the object detection model prior to re-training, applying the first sample image of the sample image set to the re-trained object detection model to generate a fourth output of the re-trained object detection model, transmitting, to the client device, the third output of the object detection model and the fourth output of the re-trained object detection model, receiving, from the client device, user feedback indicating accuracy of the fourth output of the re-trained object detection model relative to the third output of the object detection model, and reverting the re-trained object detection model to an earlier training state responsive to user feedback indicating reduced accuracy of the fourth output of the re-trained object detection model, wherein the sample image set includes a plurality of images which are not used in training the object detection model.

In an embodiment, the instructions further include instructions that, when executed by the computing system, cause the computing system to perform operations including repeating steps of applying, transmitting, receiving, updating, and re-training until each image of the plurality of training images have been labeled.

In an embodiment, a method includes: receiving a plurality of training images, the training images including a set of labeled training images and a set of unlabeled training images, training an object detection model using the set of labeled training images, applying one or more images of the set of unlabeled training images to the object detection model to generate a first output of the object detection model, transmitting the first output of the object detection model, receiving user feedback indicating accuracy of the first output of the object detection model, updating the set of labeled training images by labeling one or more images of the set of unlabeled training images according to the user feedback, and re-training the object detection model using the updated set of labeled training images.

In an embodiment, re-training the object detection model using the updated set of labeled training images includes receiving an indication by the user to initialize re-training of the object detection model, and re-training the object detection model using the updated set of labeled training images responsive to the indication.

In an embodiment, re-training the object detection model using the updated set of labeled training images includes adjusting a re-training interval based on a static interval and a quantity of user feedback received, determining that the re-training interval has elapsed since the object detection model was last trained, and re-training the object detection model using the updated set of labeled training images.

In an embodiment, re-training the object detection model using the updated set of labeled training images includes determining, based on the user feedback, that an error threshold of the object detection model has been met, and re-training the object detection model using the updated set of labeled training images responsive to meeting the error threshold.

In an embodiment, the error threshold of the object detection model includes a percentage of outputs of the object detection model for which the user feedback includes a corrective object label.

In an embodiment, the method further includes identifying a group of two or more images of the set of unlabeled training images having a high degree of similarity, identifying a representative image of the group, applying the representative image to the object detection model, receiving user feedback indicating accuracy of a corresponding output of the object detection model, the user feedback including confirmation of the output, and labeling each image of the group according to the output of the object detection model.

In an embodiment, the representative image of the group is classified as a high-value image for training the object detection model.

In an embodiment, the method further includes receiving, from an image sensor, the set of unlabeled training images, transmitting, to a client device, the first output of the object detection model, and sending for display, in a user interface of the client device, a notification alerting the user to provide feedback indicating accuracy of the first output.

In an embodiment, updating the set of labeled training images by labeling one or more images of the set of unlabeled training images according to the user feedback includes updating a plurality of object labels according to the user feedback, wherein each object label of the plurality of object labels is associated with one or more images of the set of unlabeled training images.

In an embodiment, the method further includes calculating, for each image of the set of unlabeled training images, a similarity index, identifying, based on similarity indices, a group of two or more unlabeled training images meeting a similarity threshold, applying one image of the group of two or more unlabeled training images to the object detection model, and updating an object label corresponding to the group of two or more unlabeled training images responsive to user feedback.

In an embodiment, training an object detection model using the set of labeled training images includes determining a first set of weights associated with the set of labeled training images, and training the object detection model using the first set of weights.

In an embodiment, re-training the object detection model using the updated set of labeled training images includes determining a second set of weights associated with the updated set of labeled training images for which user feedback on the accuracy of the object detection model was received, and re-training the object detection model using the second set of weights associated with the updated set of labeled training images.

In an embodiment, a system includes a set of processors and a non-transitory computer-readable storage medium including stored instructions, the instructions when executed by the set of processors cause the set of processors to perform operations including receiving a plurality of training images, the training images including a set of labeled training images and a set of unlabeled training images, wherein labels of the labeled training images are received from a client device of a user, training an object detection model using the set of labeled training images, applying one or more images of the set of unlabeled training images to the object detection model to generate a first output of the object detection model, transmitting, to the client device, the first output of the object detection model, receiving, from the client device, user feedback indicating accuracy of the first output of the object detection model, updating the set of labeled training images by labeling one or more images of the set of unlabeled training images according to the user feedback, and re-training the object detection model using the updated set of labeled training images.

### Examples of a Computing System and System Environment

Aspects of the present disclosure relate to machine learning-driven object detection. A computing system implements an object detection model based on feedback from a user. A detection engine assesses the accuracy of the object detection model's outputs. The computing system may leverage classifier heads to determine whether to provide the object detection model's outputs to a client device. The computing system uses user feedback, such as whether outputs were false positives (e.g.,, the model determined that a particular object was depicted in an image or video, but the user indicates that no such object was depicted), false negatives (e.g., the model failed to detect a known object in an image or video), and corrective object labels (e.g., the model determined that a particular object was depicted in an image or video, but the user indicates that the object was labeled incorrectly) to selectively re-train the object detection model.

In conventional computing systems, machine learning models are often re-trained infrequently because it is difficult and time consuming to acquire a sufficient amount of new training data for re-training the model) or the system cannot afford to expend processor resources or time to frequently re-train the model. This can sacrifice detection accuracy, which can be critical in computing systems where a person or property's safety is at risk.

Disclosed is a computing system which can iteratively re-train an object detection model responsive to user feedback, providing enhanced object detection accuracy. In certain embodiments, the computing system can facilitate rapid re-training of the object detection model by identifying specific training media frames having an increased importance for training the object detection model. The user can provide feedback associated with these specific training media frames to preferentially include in a training data set.

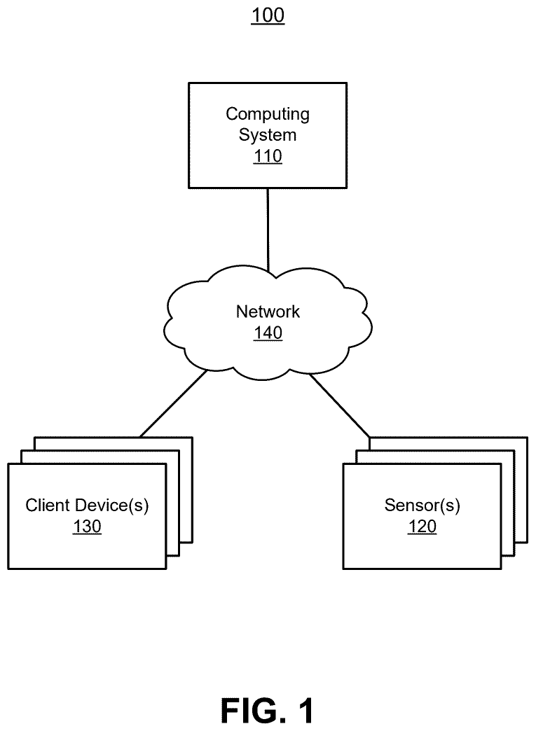

FIG. 1 illustrates a block diagram of a system environment 100 in which a computing system 110 operates, in accordance with one embodiment. The system environment 100 includes a computing system 110, sensor(s) 120, client device(s) 130, and a network 140. The system environment 100 may have alternative configurations than shown in FIG. 1, including different, fewer, or additional components.

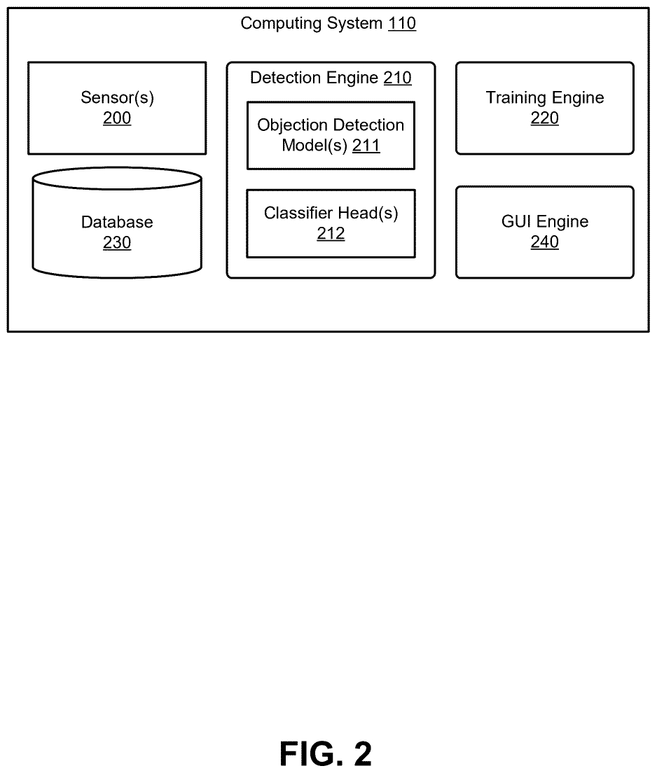

The computing system 110 implements machine learning-driven object detection. The computing system 110 may reside on a remote server communicatively coupled to the client device(s) 130. Although the computing system 110 is depicted as remote from the client device(s) 130, in alternative embodiments, the computing system 110 may reside on the client device(s) 130 and be executed from the client device(s) 130. Although the computing system 110 may be described as being applied to security uses, the machine learning-driven object detection of the computing system 110 may be applied to non-security uses involving object detection. The computing system 110 is described further with respect to the description of FIG. 2.

The sensor(s) 120 capture image data that may depict potential security threats. The sensor(s) 200 can include an imaging camera, infrared camera, depth camera, or any suitable optical sensor for capturing image data. The sensor(s) 120 may be co-located with other components of the computing system 110 or located remotely (e.g., a camera located on a satellite that transmits the captured images to a ground-based remote server). The image data may include video or images. In some embodiments, the sensor(s) 120 may capture non-image data that may indicate a potential security threat. For example, the sensor(s) 120 may include a microphone that captures audio. The computing system 110 may train a machine learning model to detect activity or objects from non-image data (e.g., a machine learning model trained to detect an object (e.g. boats) from noises caused by that object (e.g., the sound of boat engines)).

A client device, such as the client device(s) 130, may be a personal computer (PC), a tablet PC, a smartphone, or any suitable device capable of executing instructions that specify actions to be taken by that device. The client device(s) 130 may include one or more processors (e.g., one or more central processing units (CPUs), one or more graphics processing units (GPUs), one or more digital signal processors (DSPs), one or more application specific integrated circuits (ASICs), one or more radio-frequency integrated circuits (RFICs), or any combination of these), a memory, a user interface to receive user inputs or provide outputs to the user (e.g., a visual display interface including a touch enabled screen, a keyboard, microphone, speakers, etc.). The visual interface may include a software driver that enables displaying user interfaces on a screen (or display).

The network 140 may serve to communicatively couple the computing system 110, the sensor(s) 120, and the client device(s) 130. In some embodiments, the network 140 includes any combination of local area and/or wide area networks, using wired and/or wireless communication systems. The network 140 may use standard communications technologies and/or protocols. For example, the network 306 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 306 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network may be represented using any suitable format, such as hypertext markup language (HTML) or extensible markup language (XML). In some embodiments, all or some of the communication links of the network 140 may be encrypted using any suitable technique or techniques.

FIG. 2 depicts a block diagram of the computing system 110 of FIG. 1, in accordance with one embodiment. The computing system 110 includes sensor(s) 200, a detection engine 210, a training engine 220, a database 230, and a graphical user interface (GUI) engine 240. The sensor(s) 200 may be similar to the sensor(s) 120. The detection engine 210, the training engine 220, and the GUI engine 240 may be software modules executed on a computer (e.g., a remote server or a client device). The computing system 110 may include additional, fewer, or different components than depicted in FIG. 2. For example, the sensor(s) 200 may be excluded from the computing system 110 and instead, the computing system 110 may be communicatively coupled to third party sensors. The computing system 110 may be executed across two or more computer systems. For example, an object detection model may be executed on a remote server while a classifier head may be executed on a client device.

The detection engine 210 detects objects within image or audio data. The detection engine 210 includes one or more object detection model(s) 211 and one or more classifier head(s) 212. Although depicted together, the object detection model(s) 211 and the classifier head(s) 212 may be executed on separate computer systems. For example, an object detection model 212 may be executed on a remote server while a classifier head that receives the output of the object detection model 212 is executed on a client device 130. The object detection model 212 may detect non-objects in addition or alternative to objects. For example, an object detection model 212 may be trained to detect living entities (e.g., animals or humans) or an activity happening over time (e.g., a weather phenomenon or a criminal activity).

The object detection model(s) 211 and the classifier head(s) 212 may be machine learning models. Example models used by the detection engine 210 include text classifiers, computer vision models, diagnostic models, transformers, autoencoders, or any suitable trained machine learning model.

The detection engine 210 may determine a context parameter for selecting a particular classifier head for application using user feedback. The context parameter may characterize one or more of images input to the object detection model or user feedback of the output of the object detection model. Examples of context parameter include a type of client device, an environment type depicted in the images input into the object detection model, or a client application for which the output of the object detection model is used. A client application may be a software application executable by a client device 130. Each of the classifier heads may be trained to specialize in determining the accuracy of the object detection model 211 with respect to a particular context parameter. For example, a first classifier head specializing in determining the accuracy of the object detection model 211 when detecting objects made by a particular manufacturer may be trained by using user feedback on images of the object made by the particular manufacturer.

In some embodiments, the detection engine 210 may determine the context parameter to identify one or more images input to the object detection model 211 for which user feedback is desired. The context parameter is not necessarily associated with selecting a particular classifier head.

The detection engine 210 may receive the context parameter for selecting a particular classifier head from a user input provided through the client device. The detection engine 210 may receive from a client device 130 a selection of a context parameter. The detection engine 210 may provide a list of possible context parameters from which the user may select one or more context parameter. The detection engine 210 may determine the context parameter automatically. For example, the detection engine 210 may receive a hardware identifier with the user feedback, where the hardware identifier specifies a type of client device that the training engine 220 uses as the context parameter.

The training engine 220 may train or re-train a model based on one or more training algorithms. Examples of training algorithms may include mini-batch-based stochastic gradient descent (SGD), gradient boosted decision trees (GBDT), support vector machine (SVM), neural networks, logistic regression, naïve Bayes, memory-based learning, random forests, decision trees, bagged trees, boosted trees, or boosted stumps.

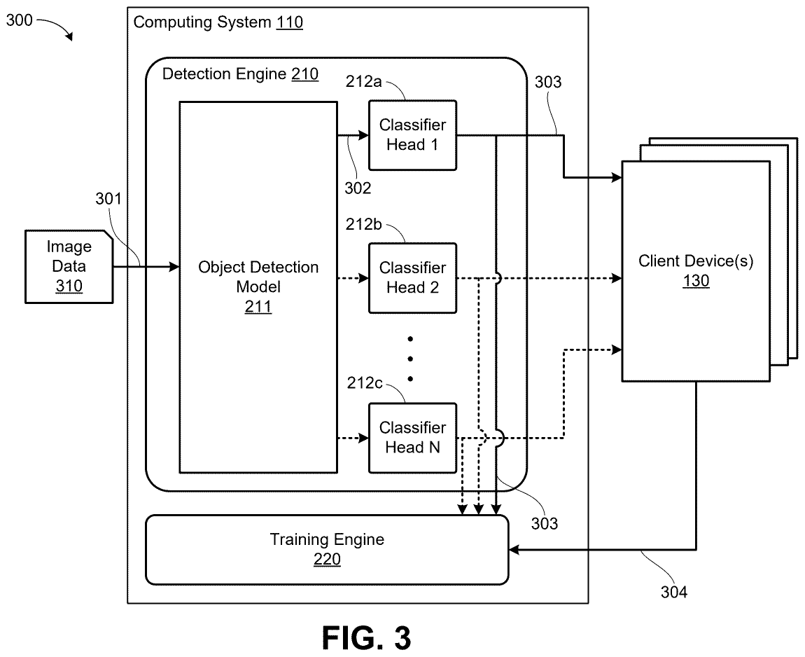

The training engine 220 may train or re-train a classifier head using user feedback data associated with a particular context parameter. For example, the training engine 220 may train the classifier head 212a (e.g., see FIG. 3) using user feedback from a first client device of the client devices 130 and train the classifier head 212b using user feedback from a second client device of the client devices 130. In another example, the training engine 220 may train the classifier head 212a using user feedback for object detection for a camera detecting smoke or fire in a kitchen (e.g., a first client application) and train the classifier head 212b for object detection in satellite images for an emergency weather service detecting wildfire smoke (e.g., a second client application).

In some embodiments, the detection engine 210 may apply two or more classifier heads 212 to the output of the object detection model 211 and provide the outputs of those two or more classifier heads 212 to the client device(s) 130. A user may provide feedback indicating the accuracy for each of the outputs of those two or more classifier heads 212. Using the user feedback, the detection engine 210 may determine one of the classifier heads 212 for which the user is indicating a higher accuracy. The detection engine 210 may apply that classifier head 212 rather than other classifier heads 212 until the detection engine 210 begins to receive negative user feedback of the detection accuracy. For example, the detection engine 210 may determine that the accuracy has fallen below a threshold accuracy or that the ratio of positive user feedback to negative user feedback (e.g., positive feedback meeting a threshold accuracy level) for the last N>0 instances of user feedback has fallen below a particular threshold ratio. In response, the detection engine 210 may return to applying two or more classifier heads 212 to the output of the object detection model 211 and determine which of the two or more classifier heads 212 is garnering the most positive feedback (or satisfying some other metric for accuracy).

The output of the object detection model 211 may be transmitted to one or more of the client device(s) 130 based on the output of a classifier head 212. For example, in response to the first classifier head 212a determining that the likelihood that the object detection model output meets a threshold accuracy, the detection engine 210 transmits the object detection model output to a client device. In response to the first classifier head 212a determining that the likelihood that the object detection model output does not meet the threshold accuracy, the detection engine 210 does not transmit the object detection model output to the client device. The detection engine 210 may, rather than transmitting the object detection model output that does not satisfy the threshold accuracy, store the output as a negative example for subsequent re-training of the object detection model 211. The detection engine 210 may store the output with a label indicating that the object was not detected in the image input into the object detection model 211.

The training engine 220 can train or re-train the object detection model(s) 211 or classifier head(s) 212. The training engine 220 may use subsampling of various training datasets to re-train an object detection model. For example, the training engine 220 may subsample the original training dataset and a dataset including object labels applied based on user feedback of the model's detection outputs, which enables the re-trained object detection model to learn object detection from new data while not forgetting what the model has learned from training data of an earlier iteration of the model.

Advantages of the present computing system 110 include increasing the accuracy of a trained object detection model and reducing the time needed to re-train the object detection model. Moreover, the computing system 110 can avoid catastrophic forgetting, which is a tendency of a machine learning model to forget previously learned information upon learning new information. When affected by catastrophic forgetting, a machine learning model may lose an ability to perform on previously learned tasks when it is trained on new tasks. Hence, conventional computing systems that retrain models with new data may cause the models to deteriorate when retraining due to catastrophic forgetting. By re-training an object detection model with a sample (or subsample) of the original training dataset and a dataset including object labels applied based on user feedback of the model's detection outputs, the present computing system 110 can help prevent the object detection model from deteriorating in its accuracy.

The training engine 220 may label outputs of the object detection model 211 as a positive or negative example based on the user feedback. The user feedback may be a binary value associated with a successful or unsuccessful detection. A classifier head trained with these binary labels may predict whether a given output of the object detection model 211 is successful or unsuccessful for that particular context parameter. Alternatively, the user feedback may reflect a percentage of accuracy (e.g., the user specifies 50% accurate if the output of the object detection model 211 outputs an image with a boundary box over half the object the model was trained to detect). The user feedback reflecting a percentage of accuracy may be non-numerical feedback, such as dragging edges of the boundary box in a graphical user interface to revise (e.g., correct) a detection by the object detection model 211. The training engine 220 may calculate a numerical percentage of accuracy based on non-numerical user feedback. The training engine 220 may label outputs of the object detection model 211 with the percentage of accuracy indicated by the user feedback. A classifier head trained with non-binary labels may predict a corresponding non-binary likelihood whether a given output of the object detection model 211 is successful or unsuccessful.

One or more of the classifier heads 212 may be a hardware-aware classifier, which is a classifier trained depending on a type of hardware at which the object detections are used or where the classification of the classifier head executed. The training engine 220 may determine a type of hardware of a client device based on a hardware identifier of the client device. The training engine 220 may train a classifier head using one of a full precision training, half precision training, 8-bit precision, or mixed precision training based on a hardware identifier of the client device. For example, the training engine 220 may determine that a classifier head is being or is to be executed on a field programmable gate array (FPGA) device based on a hardware identifier of the FPGA and in response, the training engine uses a mixed precision training to train the classifier head. In another example, the training engine 220 determines that a classifier head is executed on a portable computer without a graphics processing unit and in response, the training engine 220 retrains using a slower central processing unit-based approach. The training engine 220 may perform this determination by detecting the absence of tensor-enabled hardware on the portable computer.

The training engine 220 receives user feedback from the client device(s) 130. The user feedback indicates an accuracy of the output of the object detection model 211. The user feedback may be binary (e.g., a thumbs up or thumbs down), a value within a discrete range (e.g., a star rating or a percentage), or a text string (e.g., labels of one or more objects depicted in the output of the object detection model 211). The amount of negative user feedback may decrease with the inclusion of the classifier head trained to filter out outputs of the object detection model 211 that are likely inaccurate. The training engine 220 may use the user feedback to re-train a classifier head 212. In some embodiments, the training engine 220 can automatically re-train a classifier head each time user feedback is received. This re-training may happen in substantially real time. For example, the training engine 220 can begin re-training the first classifier head 212a within a minute of receiving user feedback on the output of the object detection model 211 that the first classifier head 212a had determined as meeting a threshold accuracy. In some embodiments, the training engine 220 can begin re-training the object detection model 211 in response to re-training of at least one of the classifier heads 212.

The training engine 220 may monitor the outputs of the classifier heads 212 to determine when to re-train the object detection model 211. The training engine 220 may determine that the object detection model 211 is performing to a sufficient degree of accuracy over time based on the number of classifier head outputs indicating the object detection model 211 outputs meet a threshold accuracy. For example, the training engine 220 re-trains the object detection model 211 in response to determining that at least 80% of the last fifty outputs of each of the classifier heads 212 has satisfied an accuracy threshold. In the case that different classifier heads have different accuracy thresholds, the training engine 220 may determine to re-train the object detection model 211 in response to determining that a threshold percentage of some number of recent outputs of each of the classifier heads satisfies its respective accuracy threshold.

Alternative or additional metrics for determining when to re-train the object detection model 211 may be used. For example, a minimum number of consecutive model outputs that meet an accuracy threshold, a minimum number of model outputs that both the classifier head and user feedback indicate are accurate, or any suitable metric indicating the accuracy of the object detection model 211. Metrics for determining when to re-train the object detection model 211 may be based on the outputs of a single classifier head or based on a combination of outputs of two or more classifier heads.

In certain embodiments, the training engine 220 may re-train the object detection model 211 in response to receiving a threshold amount of negative user feedback. For example, when user feedback on the outputs of the object detection model 211 is negative for more than 20% of the outputs, the training engine 220 can initialize re-training. In another example, the training engine 220 may initialize re-training after receiving a threshold number of user-provided (corrective) object labels for the outputs of the object detection model 211. The computing system 110 can also receive an indication by the user to initialize re-training of the object detection model 211, causing the training engine 220 to initialize re-training based on any previously received user feedback. In some embodiments, the training engine 220 re-trains an object detection model 211 regularly (e.g., periodically), where the frequency of re-training is based on user feedback. For example, the frequency increases with higher levels of negative user feedback and the frequency decreases with lower levels of negative user feedback.

The training engine 220 can re-train the object detection model 211 using data from one or more of the original training dataset (without any user feedback) or an updated training dataset with object labels applied based on user feedback of the model's detection outputs. For example, the training engine 220 can re-train the object detection model 211 with a dataset that is composed of (e.g., all or part of the) data from the original training dataset and (e.g., all or part of the) data from the updated training dataset. The original dataset may be a predefined dataset. For example, by using both the original training data and an updated training dataset, the training engine 220 can subsample the original training data while incorporating new data. In this way, the training engine 220 trains the object detection model 211 on new data while enabling the model 211 to “remember” training data of an earlier iteration of the model.

The training engine 220 can generate the updated training dataset by labeling image data received from sensors (e.g., the sensor(s) 120 or the sensor(s) 200) using labels based on user feedback. For example, the training engine 220 labels an image of a person detected by an object detection model configured to detect people with a “person” label because the user feedback indicated that the detection was accurate. In another example, the training engine 220 labels an image with a person that was not detected by the object detection model with a “person” label because the user feedback indicated that the detection was inaccurate (e.g., the user feedback included a label of the person and the training engine 220 applies that label to the image).

The training engine 220 may label an image with a user-provided object label if one or more object labels are provided in the user feedback. For example, user-provided object label(s) can identify specific objects present in the output of the object detection model 211 that were not detected by the model. In another example, user-provided object labels can clarify an identification where the object detection model 211 has already detected an object. For example, the user may indicate that the “person” label was correctly generated by the object detection model 211 and provide an object label of “person, male, Caucasian, six-foot two inches” for the training engine 220 to apply to the updated training dataset.

The training engine 220 may re-train the object detection model 211 using a k-fold cross validation (but in other embodiments the training engine 220 may re-train the object detection model 211 using other techniques). The training engine 220 may sample (or subsample) from one or more of the original training dataset or an updated training set and re-train the object detection model 211 using two or more permutations of sampled (or subsampled) data. In some embodiments, sampling by the training engine 220 may include accessing the original training dataset in its entirety, accessing a subset of the original training dataset, accessing the updated training set, or any combination thereof. For example, the training engine 220 can create three different training datasets, each training dataset having a portion of labeled data from the original training dataset and the updated training set, wherein the updated training set includes object labels applied based on user feedback of the model's detection outputs. The training engine 220 can re-train the object detection model 211 using each of the three different training datasets and select one of the three re-trained versions of the object detection model 211 to use for detection. The training engine 220 may select the re-trained version having the highest accuracy.

The training engine 220 can re-train the object detection model 211 using an initial set of weights different from the initial set of weights originally used to train the object detection model. The training engine 220 may use the last best weights to re-train the object detection model. The training engine 220 may identify the last best weights by storing records of weights of the object detection model mapped to an accuracy of one or more outputs produced by the object detection model 211 with the respective weights. The training engine 220 may access, from the records, which weights are associated with the highest accuracy of outputs of the object detection model 211. The training engine 220 may begin re-training the object detection model using the last best weights instead of using the initial set of weights used to train the object detection model. The training engine 220 may determine a first set of weights associated with the original training dataset for training the object detection model, and subsequently determine a second set of weights associated with a new (e.g., updated) training dataset for which user feedback on the accuracy of the object detection model was received. The training engine 220 may initially train the object detection model using the first set of weights and subsequently re-train the object detection model using the second set of weights.

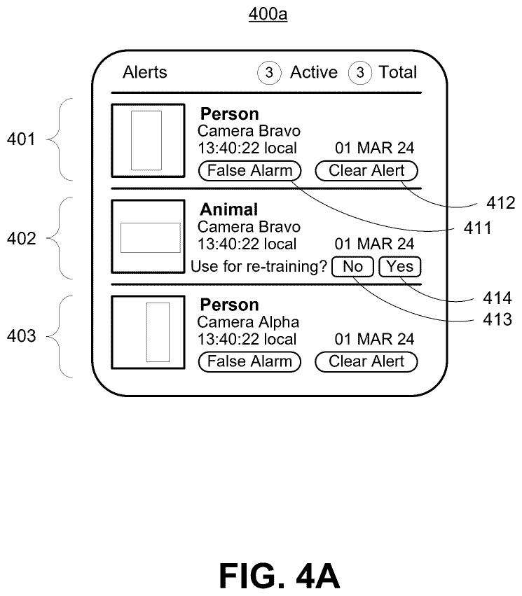

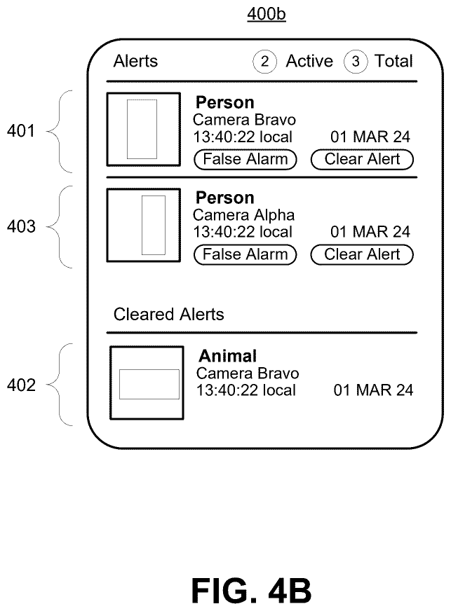

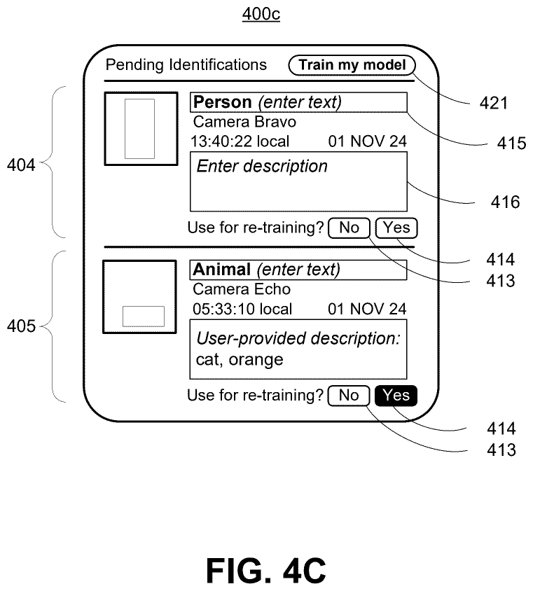

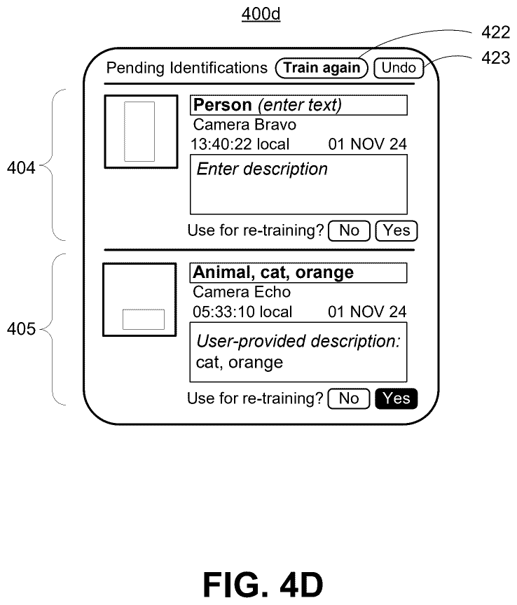

The database 230 can store training datasets, image or audio data transmitted by the sensor(s) 200, and user feedback received from the client device(s) 130. The graphical user interface (GUI) engine 240 may generate a GUI through which a user can generate training data for an object detection model (e.g., label objects in images), initiate application of an object detection model 211 to a set of data, receive notifications of object detections made by the object detection model 211, view the object detections,, provide feedback on the accuracy of the object detections, initialize re-training by the training engine 220, or any combination thereof. The GUI engine 240 may update generated GUIs in response to user interactions. Examples of generating and updating GUIs are depicted in FIGS. 4A-4D.

FIG. 3 shows a block diagram of a process 300 for re-training machine learning models of the computing system 110 of FIG. 1, in accordance with one embodiment. The process 300 may include additional, fewer, or alternative operations than described in the description of FIG. 3. While components of the computing system 110 are depicted in FIG. 3 as being executed from a remote server (separate from the client device(s) 130), one or more of the components may be located at and executed from the client device(s) 130. For example, each client device 130 may host and execute a respective classifier head 212 rather than the classifier heads 212 being executed on a remote server.

The computing system 110 receives 301 image data 310. The image data 310 is input into the object detection model 211 of the detection engine 210. The output of the object detection model 211 indicates whether a particular object was depicted in the image data 310. The output of the object detection model 211 is transmitted 302 to a first classifier head 212a of the classifier head(s) 212. The first classifier head 212a determines a likelihood that the output of the object detection model 211 is accurate. If the output meets an accuracy threshold, the detection engine 210 causes the output of the object detection model 211 to be transmitted 303 the client device(s) 130. The output is also transmitted 303 to the training engine 220 for re-training one or more of the object detection model 211 or the classifier head(s) 212 (e.g., the first classifier head 212a). The computing system 110 receives 304 user feedback from the client device(s) 130. The training engine 220 may label the output of the object detection model 211 according to the received 304 user feedback and use the labeled data to re-train a machine learning model of the detection engine 210. Although not depicted, the received 304 user feedback or the labeled data may be stored in the database 230.

Although not depicted, the detection engine 210 may operate before the classifier heads 212 have been trained. That is, the detection engine 210 may detect a particular object depicted within the image data 310 with the object detection model 211 and provide the output of the object detection model 211 directly to the client device(s) 130. The output of the object detection model 211 is not input to a classifier head 212 when none of the classifier heads have been trained yet, if none of the classifier heads have an appropriate context parameter (e.g., there is no matching classifier head for a specific sensor configuration, environment type, client device, etc.), or in embodiments of the computing system 110 without a classifier head 212. In such cases, the training engine 220 can receive user feedback on the direct output of the object detection model 211 to train a classifier head.

The detection engine 210 may determine to apply a first classifier head 212a to the output of the object detection model 211 based on a context parameter in which the first classifier head 212a specializes (e.g., is trained for that context parameter). For example, the first classifier head 212a may be specialized for a particular type of client device after the computing system 110 has trained the classifier head 212a on feedback provided solely or primarily from that type of client device. In another example, the first classifier head 212a may be specialized for a particular environment type after the computing system 110 has trained the first classifier head 212a on feedback provided solely or primarily on images depicting that particular environment. The application of the first classifier head 212a rather than other classifier heads is shown through a solid line going from the object detection model 211 to the classifier head 212a and to the client device 130. The dashed lines from the object detection model 211 to the other classifier heads (e.g., heads 212b and 212c) indicate that the other classifier heads were not applied to the output of the object detection model 211 or that the output from those other classifier heads are not transmitted to the client device 130.

In one example of the process 300, the image data 310 depicts an image of an individual obscured by trees and an object detection model of the object detection model(s) 211 is configured to detect an accessory bag (e.g., a backpack or purse) carried by a person. The computing system 110 is configured to determine whether the individual depicted is carrying an accessory bag. The object detection model 211 receives 301 the image data 310 and determines that an accessory bag is detected in the image data 310. The output of the object detection model 211 is transmitted 302 to the classifier head 212a in response to the detection engine 210 determining that the classifier head 212a has been trained on images of accessory bags in a forest environment and that the sensor that provided the image data 310 is located in a forest.

The first classifier head 212a determines whether the output of the object detection model 211 correctly classified an accessory bag as being in the image data 310. In response to determining that the output meets a threshold accuracy for being classified correctly, the detection engine 210 transmits 303 the output of the object detection model 211 to a client device of the client device(s) 130.

A user of the client device may determine that the output did not depict an accessory bag and thus, the computing system 110 had provided a false positive detection. The computing system 110 may receive 304 feedback from the user's client device indicating that no accessory bag is depicted in the image data 310. The training engine 220 labels the image data 310 or the output of the object detection model 211 according to the user's feedback. The training engine 220 thus creates a negative example.

In other instances, the user of the client device may recognize that the output did depict an accessory bag but was not correctly classified and thus, the computing system 110 has provided a false negative detection. The computing system 110 may receive 304 feedback from the user's client device indicating that an accessory bag is depicted in the image data 310. The training engine 220 labels the image data 310 or the output of the object detection model 211 according to the user's feedback. The training engine 220 thus creates a positive example.

The example(s) created by the training engine 220 may be used to re-train the object detection model 211, the classifier head(s) 212, or a combination thereof. For instance, the training engine 220 may use the negative example or the positive example to re-train the first classifier head 212a, which incorrectly determined that the output of the object detection model 211 was accurate, in substantially real time after creating the example(s). For example, within a minute of adding the negative example to the database 230, the training engine 220 may re-train the classifier head 212a such that subsequent classifications by the classifier head 212a may increase in accuracy. In other instances, the training engine 220 may initialize re-training once a threshold amount of user feedback (e.g., a threshold percentage of negative user feedback) has been received. The training engine 220 may continue to create new training data and re-train one or more of the classifier heads 212 as new image data applied to the object detection model 211 and user feedback on the accuracy of the detections are received. This incremental, iterative training allows for the output of the detection engine 210 to improve its accuracy more frequently than conventional systems that would wait to re-train the classifier head 212a after gathering sufficient training data.

The training engine 220 determines when to re-train the object detection model 211. For example, after determining that the image data 310 transmitted 303 was inaccurate based on the user feedback, the training engine 220 may determine to wait to re-train the object detection model 211. The training engine 220 may store the labeled image data 310 as a positive example or a negative example in accordance with user feedback for re-training the object detection model. In response to a successful object detection that is reported to the user who does not provide negative feedback (e.g., clears a notification asking if the output is a false positive) or provides positive feedback (e.g., provides a “thumbs up” on a notification generated on a GUI by the GUI engine 240), the training engine 220 may label the corresponding image data depicting an accessory bag as a positive example and determine whether the classifier head 212a has met a metric that triggers re-training the object detection model 211. For example, the training engine 220 may determine that the classifier head 212a has correctly classified at least 90% of the last one hundred detections as accurate and in response, the training engine 220 determines to re-train the object detection model 211. In another example, the training engine 220 determines that a threshold number of user-provided object labels have been added to the updated training dataset since the object detection model 211 was last trained, causing the training engine 220 to initialize re-training.

FIGS. 4A-4B depict GUIs 400a and 400b that include notifications generated by the computing system 110 of FIG. 1, in accordance with one embodiment. FIGS. 4C-4D depict GUIs 400c and 400d that include notifications generated by the computing system 110 of FIG. 1, in accordance with an additional embodiment. The GUIs 400a-400d can be generated by the GUI engine 420. A notification generated by the GUI engine 420 may include a request for user feedback. The GUIs 400a-400d may include additional, fewer, or different graphical display elements (e.g., buttons, scroller bars, tabs, text boxes, etc.). The GUIs 400a-400d may be displayed at the client device(s) 130.

The GUI 400a depicts alert notifications 401, 402, and 403. The notifications 401 and 403 include buttons for providing feedback to the computing system 110. In particular, a button 411 provides, when selected, feedback to the computing system 110 that the detection of a person in the image taken by Camera Bravo was inaccurate (e.g., there was no person in the image or video, indicating a false positive detection). In some instances, the GUI 400a may allow the user to provide more detailed feedback on a false positive detection, such as by applying a user-provided object label to an incorrectly identified object (see, e.g., GUIs 400c-400d discussed below). A button 412 provides, when selected, feedback to the computing system 110 that the detection of the person in the image was accurate. The notification 402 includes buttons for instructing the computing system 110 to use a particular data point for re-training one or more of an object detection model or a classifier head. In particular, a button 413 instructs, when selected, the computing system 110 to omit the possible animal detection as a data point for re-training and a button 414 instructs, when selected, the computing system 110 to include the data point for re-training.

The GUI 400b depicts an updated interface to the GUI 400a after the user has interacted with the alert notification 402. The GUI engine 420 may cause the GUI 400b to be displayed after receiving a user selection of the button 413 or the button 414, which can cause the GUI engine 420 to clear the alert notification 402 and display the alert notification 402 under a “Cleared Alerts” section of the GUI 400b.

In some instances, image data may include known examples of objects expected to cause an object detection alert to be displayed in the GUI 400a (e.g., sample images). However, the object detection model or classifier head may not successfully detect the object and generate an alert (e.g., a false negative). Because an alert was not generated, the user may provide feedback via a different GUI. For example, the user may access a second GUI (e.g., a sub-window or GUI pane displaying sample images in a grid view) to mark the false negative examples as requiring additional review. Marking the false negative examples can cause the example images to populate a “needs review” tab of the second GUI for the user to annotate (e.g., by drawing bounding boxes around the example objects or adding user-provided object labels) so the user annotations can be included in an updated training data set.

A training data set (e.g., the updated training data set) may include metadata (e.g., user annotations) for each image configured to cause the GUI 400a to display a false negative alert (e.g., “IMG_0158 object not detected”) when a corresponding object detection alert is not generated by the object detection model. As such, the user can test the object detection model on the training data set to automatically alert the user to missed examples.

The GUI 400c depicts alert notifications 404 and 405. The notifications 404 and 405 include buttons and text fields for providing feedback to the computing system 110. In particular, a title field 415 initially displays a generated object label associated with the output of the object detection model 211. A description field 416 allows the user to append clarifying object labels to be included in the updated training dataset. For example, when the generated object label associated with the output of the object detection model 211 is incorrect, the user can provide negative feedback by overwriting the title field 415 with a corrective object label. Alternatively, the user may supplement a correct output of the object detection model 211 by entering one or more ancillary object labels (e.g., physical attributes of a person or animal, models or designations of vehicles, aircraft, etc.) in the description field 416 to aid in future identification. The notifications 404 and 405 include buttons for instructing the computing system 110 to use a particular data point for re-training one or more of an object detection model or a classifier head. In particular, a button 413 instructs, when selected, the computing system 110 to omit a possible detection as a data point for re-training and a button 414 instructs, when selected, the computing system 110 to include the data point for re-training.

The GUI 400c further includes a button 421 that, when selected, causes the training engine 220 to initialize re-training of the object detection model 211 based on an updated training dataset including any previously received user feedback. For example, the button 421 may cause a request for re-training to be transmitted by the client device 130 to the training engine 220. In some embodiments, the request for re-training may include user feedback in the form of one or more user-provided object labels for inclusion in the updated training dataset. In other embodiments, user feedback is received from the client device 130 at the time it is entered in the user interface 400c, and the button 421 may be used to manually initialize re-training between regular re-trainings by the training engine 220. Accordingly, the GUI 400c allows the user to review object detections, generate updated training data for the object detection model 211 (e.g., label objects in images), initiate application of an object detection model 211 to a set of data, initiate training of the object detection model 211, or any combination thereof.

The GUI 400d depicts an updated interface to the GUI 400c after re-training of the object detection model 211 by the training engine 220. The GUI engine 420 may cause the GUI 400d to be displayed after receiving a user selection of the button 421. (A similarly updated interface can be displayed when automatic re-training is triggered.) The GUI 400d illustrates that user-provided object labels (e.g., “cat, orange”) have been included in the updated training dataset and are therefore reflected in the output of the re-trained object detection model 211.

The GUI 400d includes a training button 422 to re-train the object detection model 211 again (similar to the button 421) and an “undo” button 423 to revert the model 211 to a previous iteration. In cases of over-fitting or other erroneous behavior, selecting the “undo” button 423 can cause the detection engine 210 to revert the object detection model 211 to a cached version from before re-training. In some embodiments, the database 230 may store a version history of the object detection model 211, allowing the detection engine 210 to switch between two or more versions of the model 211 at the request of the user. This can facilitate rapid comparison of the outputs of the object detection model 211 to monitor the efficacy of user feedback.

For example, in an embodiment, the computing system 110 can apply a sample image (or a sample set of images) not used in training an object detection model 211 to the object detection model 211 to generate an output of the object detection model prior to re-training and apply the same sample image to the re-trained object detection model to generate an output of the object detection model after re-training. Among other advantages, this may enable comparisons of different trained versions of the object detection model 211 to determine whether re-trained versions of the object detection model 211 are more accurate. The client device 130 can provide feedback as to the accuracy of both outputs, causing the computing system 110 to revert the re-trained object detection model to its initial training state (or any earlier iteration) responsive to user feedback indicating reduced accuracy of the output of the re-trained object detection model.

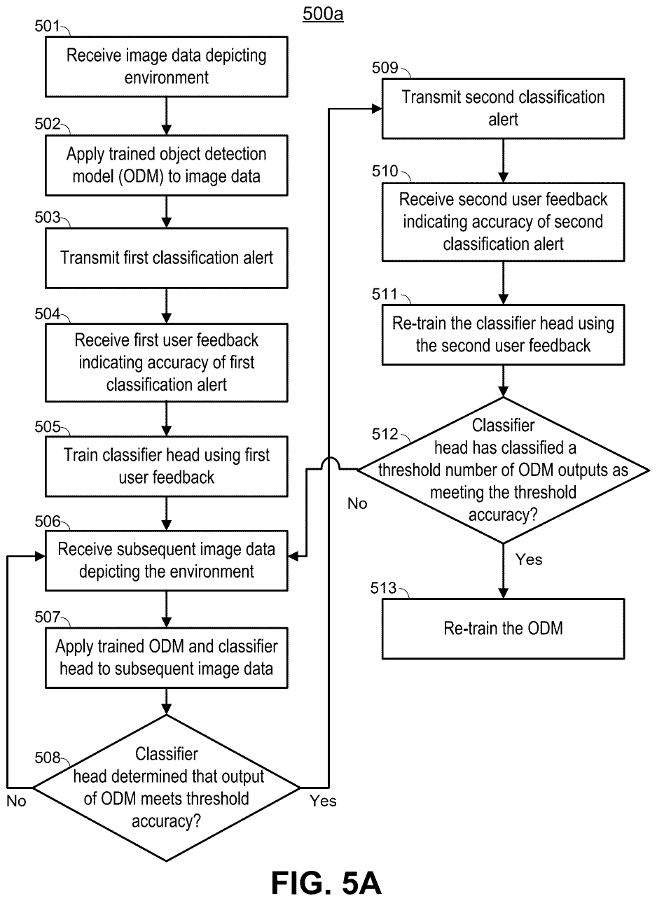

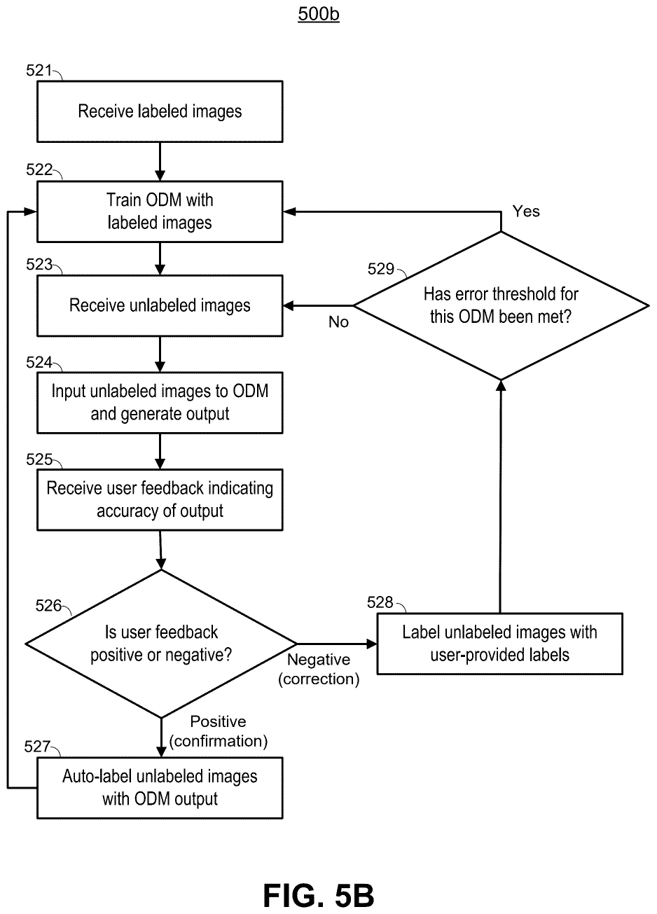

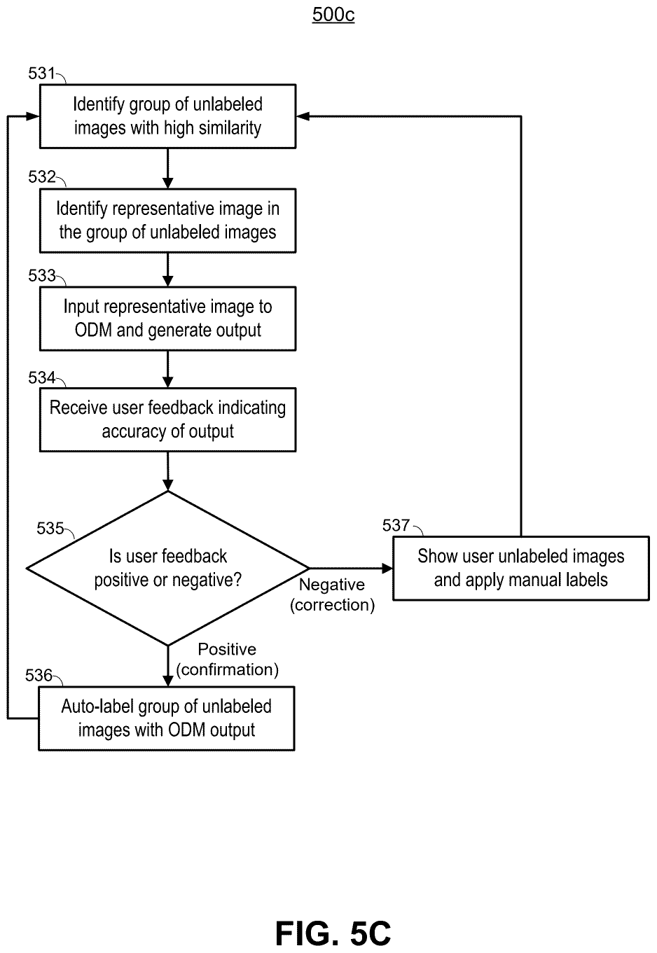

FIG. 5A depicts a flowchart of a process 500a for re-training machine learning models of the computing system 110 of FIG. 1, in accordance with one embodiment. FIG. 5B depicts a flowchart of a process 500b for re-training machine learning models of the computing system 110 of FIG. 1, in accordance with another embodiment. FIG. 5C depicts a flowchart of a process 500c for modifying the re-training process 500b of FIG. 5B. Operations of the processes 500a-500c may be performed by the computing system 110. The processes 500a-500c may include additional, fewer, or different operations than shown in FIGS. 5A-5C. Operations of the processes 500a-500c may be performed in a different order than shown in FIGS. 5A-5C (e.g., in parallel rather than in series).

Referring initially to the process 500a for re-training machine learning models, the computing system 110 receives 501 image data depicting an environment. In one example, the environment may depict an aircraft. The computing system 110 applies 502 a trained object detection model to the image data. The object detection model may be trained to detect aircrafts in images or videos. The object detection model may determine that the image data does depict an aircraft. The computing system 110 transmits 503 a first classification alert to a client device. The first classification alert may specify that there is an aircraft in the image.

The computing system 110 receives 504 a first user feedback indicating accuracy of the first classification alert. In the case of an incorrect detection by the object detection model, the first user feedback may indicate a false positive was detected. In the case of a missed detection by the object detection model (e.g., where the user expected one or more classification alerts to be generated based on the content of the image data), the first user feedback may indicate a false negative occurred. In other instances, the first user feedback may confirm the output of the object detection model is correct. For example, the first user feedback may indicate that there was no false positive or false negative because the user can confirm that an aircraft is indeed depicted in the received 501 image data. The computing system 110 trains 505 a classifier head using the first user feedback. The computing system 110 labels the output of the object detection model as accurate and can train the classifier head using the labeled output. In some embodiments, the training engine 220 of the computing system 110 may initiate training of a classifier head in response to determining a threshold amount of user feedback has been obtained to train the classifier head.

The computing system 110 receives 506 subsequent image data depicting the environment. For example, the computing system 110 can receive 506 another image from the same sensor that captured the received 501 image data. This subsequent image data may not depict an aircraft (e.g., a goose flying in the distance may appear aircraft-like in the image data). The computing system 110 applies 507 the trained object detection model and classifier head to the subsequent image data. The object detection model may mistake a goose depicted in the subsequent image data for an aircraft and output that an aircraft was detected. The computing system 110 determines 508 whether the classifier head determined that the output of the object detection model met a threshold accuracy. The classifier head may determine that the detection of the goose as an aircraft does not meet the threshold accuracy and in response, return to receiving 506 a subsequent image data depicting the environment.

Continuing the previous example, after receiving yet another image and determining, using the classifier head, that the image does meet the threshold accuracy, the computing system 110 transmits 509 a second classification alert to the client device in response to determining 508 that the classifier head determined that the output of the object detection model met the threshold accuracy. The transmitted 509 alert may be displayed on a GUI generated by the GUI engine 240 (e.g., as shown in FIG. 4A). The computing system 110 receives 510 a second user feedback indicating accuracy of the second classification alert. In the case of an incorrect determination by the classifier head, the second user feedback may indicate a false positive was detected. For example, in an instance where the classifier head incorrectly determined that the image of the goose met the threshold accuracy, the computing system 110 may receive the user's feedback that the goose was incorrectly identified as a plane. In other cases (e.g., where the output of the object detection model was incorrectly determined to be of low accuracy), the second user feedback may indicate a false negative occurred. For example, in an instance where the classifier head incorrectly determined that an image of the plane did not meet the threshold accuracy, the computing system 110 may receive the user's feedback that the plane image was incorrectly filtered. In other instances, the second user feedback may confirm the determination by the classifier head is correct. For example, the computing system 110 may receive 510 a second user feedback indicating that another image of an aircraft was correctly classified by the detection engine 210 as depicting an aircraft.

The computing system 110 re-trains 511 the classifier head using the second user feedback. The computing system 110 can re-train 511 the classifier head in substantially real time (e.g., within a minute of receiving the user feedback). Decreasing time intervals between re-training the classifier head may increase the likelihood that the classifier is accurately classifying the output of the object detection model 211. Conventional systems where the time in between re-training machine learning models is longer may cause those machine learning models to be inaccurate for that interval of time. The computing system 110 determines 512 whether the classifier head has classified a threshold number of object detection model outputs as meeting the threshold accuracy. For example, the computing system 110 determines 512 that the classifier head has classified at least twenty consecutive object detection model 211 outputs as being accurate and each of those outputs were confirmed by the user as also being accurate. In response to the determination 512, the computing system re-trains 513 the object detection model. If the computing system 110 determines 512 that the classifier head has not met the metric for accurate classification, the computing system 110 may return to receiving 506 a subsequent image data and the remaining operations of the process 500 until the metric is met for re-training 513 the object detection model 211.

Referring now to the process 500b for re-training machine learning models, the computing system 110 receives 521 a plurality of labeled images (e.g., labeled by a user). The plurality of labeled images may be training images of a training image dataset. The plurality of labeled images includes examples of labeled objects sought to be detected by an object detection model. The plurality of labeled images may include both positive and negative examples for object detection. The computing system 110 trains 522 an object detection model with the plurality of labeled images. The computing system 110 may train 522 the model based on one or more training algorithms. Such training algorithms may include mini-batch-based stochastic gradient descent (SGD), gradient boosted decision trees (GBDT), support vector machine (SVM), neural networks, logistic regression, naïve Bayes, memory-based learning, random forests, decision trees, bagged trees, boosted trees, boosted stumps, or any other training algorithm known to those skilled in the art. The training 522 produces a first iteration of an object detection model, hereafter referred to as a “trained object detection model”.

The computing system 110 also receives 523 a plurality of unlabeled images. The plurality of unlabeled images may be a subset of the training image dataset and can include further examples of an object sought to be detected by an object detection model. The plurality of unlabeled images can be sample images configured to test outputs of the trained object detection model. In certain embodiments, the computing system 110 can receive 523 the plurality of unlabeled images while receiving 521 the plurality of labeled images (however, only the plurality of labeled images is used in training 522 the trained object detection model). The computing system 110 inputs 524 one or more images from the plurality of unlabeled images to the trained object detection model, causing the model to generate one or more corresponding outputs.

The computing system 110 can transmit the one or more outputs of the trained object detection model to a client device 130 and receive 525 user feedback (such as from the client device 130) indicating the accuracy of each output. The user feedback can be positive or negative feedback and can include one or more user-provided object labels. In the case of negative feedback, a user-provided object label can be a corrective object label overwriting the output of the trained object detection model. In the case of positive feedback, a user-provided object label can be an ancillary object label which supplements the output of the trained object detection model. In other examples, the user may provide binary feedback (e.g., a thumbs-up) to indicate that the output of the trained object detection model is correct (e.g., or a thumbs-down to indicate incorrect output). Those skilled in the art may envision alternate embodiments of a system for receiving user feedback, including examples of user-provided object labels for re-training the object detection model.

The computing system 110 determines 526, for each output of the trained object detection model, whether the user feedback is positive or negative. For a given output, if the user feedback is positive (for example, when the user has not corrected a generated object label), the computing system 110 can automatically label 527 the corresponding input image with the output of the trained object detection model. If the user has provided one or more ancillary object labels, the user-provided object label(s) can be appended to the generated object label and applied to the corresponding input image. In response to a determination that the user feedback is negative (for example, when the user has overwritten the generated object label with a corrective object label), the computing system can label 528 the corresponding input image with the user-provided object label. Each of the input images for which user feedback of the output has been received is added to the plurality of labeled images which comprise an updated training image dataset. The updated training image dataset allows for re-training the object detection model based on user feedback, while enabling the model to ‘remember’ training data of an earlier iteration of the model, as previously discussed.

The computing system 110 further determines 529 whether an error threshold for the trained object detection model has been met. For example, if the user has provided negative feedback on a percentage of outputs exceeding 10%, the computing system 110 may trigger re-training of the trained object detection model using the updated training image dataset. In other cases, the computing system 110 may trigger re-training after a threshold number of instances of negative feedback (e.g., after the user has provided at least five corrective object labels for the training image dataset). The computing system 110 may also be configured to trigger re-training at regular intervals, such as on an hourly basis or after a minute of inactivity by the user's client device 130. A preset training interval may be modified to re-train sooner if the computing system 110 has received a quantity of user feedback which exceeds a second threshold. Re-training the trained object detection model yields a re-trained object detection model based on the updated training image dataset, causing the re-trained object detection model to implement user feedback. Where the error threshold for the trained object detection model has not been met, the computing system 110 can receive additional unlabeled images (or the user can continue to provide feedback until each image has been labeled) to further refine the updated training image dataset.

The image labeling process 500c of FIG. 5C can optionally modify the re-training process 500b via automatic labeling of similar images. For example, after receiving 523 the plurality of unlabeled images, the computing system 110 can apply image processing algorithms to identify 531 a group of two or more images of the plurality of unlabeled images having a high degree of similarity. Example image processing algorithms include Scale-Invariant Feature Transform (SIFT), Speeded Up Robust Features (SURF), Features from Accelerated Segment Test (FAST), Histogram of Oriented Gradients (HOG), structural similarity index measure (SSIM), and the like. In certain embodiments, identifying 531 a group of two or more images having a high degree of similarity includes calculating, for each image of the plurality of unlabeled images, a similarity index and identifying, based on similarity indices, a group of two or more unlabeled images meeting a similarity threshold. The computing system 110 can further identify 532 a representative image of the group of two or more images, the representative image having one or more characteristics which designate it as a high-value image for training the object detection model.

The computing system 110 inputs 533 the representative image to the trained object detection model (e.g., the representative image is applied to the trained model) to generate a representative output for the group of two or more images. Because the representative image is highly similar to the rest of the images in the group, it is assumed that the representative output is applicable to the entire group without generating a corresponding output for each of the similar images.

The computing system 110 receives 534 user feedback indicating accuracy of the representative output and determines 535 whether the user feedback is positive or negative. In response to a determination that the user feedback comprises positive feedback (e.g., a thumbs-up or no corrective object label) the computing system 110 may automatically label 536 each image of the group of two or more images according to the representative output. If the user feedback comprises negative feedback, the computing system 110 can transmit each individual image of the group of two or more images to the user's client device 130, causing the client device 130 to display 537 each image, and receiving a user-provided object label to be applied to the unlabeled images.

### Computing Machine Architecture

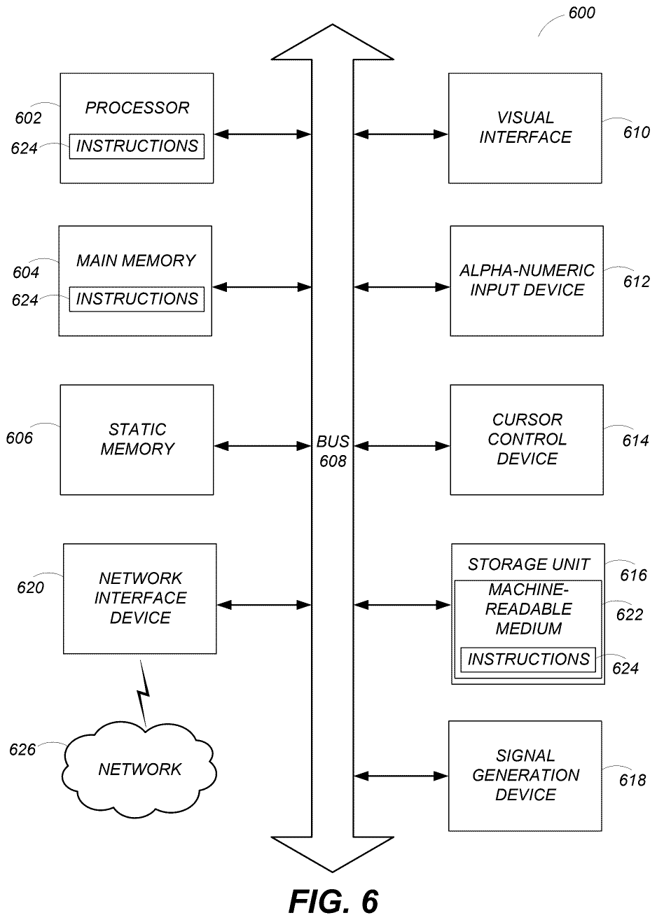

FIG. 6 is a block diagram illustrating components of an example machine able to read instructions from a machine-readable medium and execute them in a processor (or controller). Specifically, FIG. 6 shows a diagrammatic representation of a machine in the example form of a computer system 600 within which program code (e.g., software) for causing the machine to perform any one or more of the methodologies discussed herein may be executed. The program code may be comprised of instructions 624 executable by one or more processors 602. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 624 (sequential or otherwise) that specify actions to be taken by that machine. Further, while only a single machine is illustrated, the term “machine” shall also be taken to include any collection of machines that individually or jointly execute instructions 624 to perform any one or more of the methodologies discussed herein.

The example computer system 600 includes a processor 602 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 604, and a static memory 606, which are configured to communicate with each other via a bus 608. The computer system 600 may further include visual display interface 610. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 610 may include or may interface with a touch enabled screen. The computer system 600 may also include alphanumeric input device 612 (e.g., a keyboard or touch screen keyboard), a cursor control device 614 (e.g., a mouse, a trackball, a joystick, a motion sensor, or other pointing instrument), a storage unit 616, a signal generation device 618 (e.g., a speaker), and a network interface device 620, which also are configured to communicate via the bus 608.

The storage unit 616 includes a machine-readable medium 622 on which is stored instructions 624 (e.g., software) embodying any one or more of the methodologies or functions described herein. The instructions 624 (e.g., software) may also reside, completely or at least partially, within the main memory 604 or within the processor 602 (e.g., within a processor's cache memory) during execution thereof by the computer system 600, the main memory 604 and the processor 602 also constituting machine-readable media. The instructions 624 (e.g., software) may be transmitted or received over a network 626 via the network interface device 620.

While machine-readable medium 622 is shown in an example embodiment to be a single medium, the term “machine-readable medium” should be taken to include a single medium or multiple media (e.g., a centralized or distributed database, or associated caches and servers) able to store instructions (e.g., instructions 624). The term “machine-readable medium” shall also be taken to include any medium that is capable of storing instructions (e.g., instructions 624) for execution by the machine and that cause the machine to perform any one or more of the methodologies disclosed herein. The term “machine-readable medium” includes, but not be limited to, data repositories in the form of solid-state memories, optical media, and magnetic media.

### Benefits and Additional Considerations

The computing system improves the accuracy of and decreases time to generate machine learning-driven object detection (e.g., which can, in turn, decreases the risk of safety threats to individuals or property). The computing system may leverage classifier heads to improve the accuracy of the overall detection in smaller and more frequent increments. Re-training a classifier head is less processing intensive and time consuming than re-training an object detection machine learning model. The computing system can also implement multiple classifier heads, where each classifier head is trained on user feedback for a particular context in which detection occurs (e.g., using a particular sensor, images depicting a particular environment, etc.). In embodiments where classifier heads are used, the combination of the object detection model and the classifier head can thus produce an accurate object detection that is customized to various contexts in which detection is needed. Furthermore, the computing system may implement two or more classifier heads, providing further customized object detection and improved accuracy for that customized detection.

The computing system can increase the accuracy of the re-trained machine learning model by initiating the re-training with the last best weights as determined during accuracy evaluations of the machine learning model's output. Using the last best weights may result in a more accurate machine learning model than using the initial weights used to re-train the machine learning model. Having a more accurate model, the computing system may determine to re-train the machine learning model less frequently and thus, reduce processing resources that conventional systems would need to expend to re-train less accurate models.

The computing system may reduce (e.g., minimize) information leakage when applying classifier heads by implementing hardware-aware training when training the classifier heads. By selecting one of a full-precision, half-precision, mixed-precision, or any other suitable variant of machine learning model training technique based on the type of hardware on which the trained machine learning model will run, the computing system trains a model whose accuracy is sufficient for the hardware that the model is executed on. For example, the computing system will avoid training a classifier head using full precision when the device that the classifier head is to be executed on does not implement the same high degree of accuracy and would otherwise result in information leakage with the over-performing computational accuracy of the classifier head.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Throughout this specification, some embodiments have used the expression “coupled” along with its derivatives. The term “coupled” is not necessarily limited to two or more elements being in direct physical or electrical contact. Rather, the term “coupled” may also encompass two or more elements that are not in direct contact with each other, but yet still co-operate or interact with each other.

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise. Where values are described as “approximate” or “substantially” (or their derivatives), such values should be construed as accurate +/−10% unless another meaning is apparent from the context. From example, “approximately ten” should be understood to mean “in a range from nine to eleven.”

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability. Any computing systems including multiple processors may operate the multiple processors individually or collectively.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the disclosed subject matter. It is therefore intended that the scope be limited not by this detailed description, but rather by any claims that issue on an application based hereon. Accordingly, the disclosure of the embodiments are intended to be illustrative, but not limiting, of the scope, which is set forth in the following claims.

What is claimed is:

1. A non-transitory computer-readable storage medium comprising stored instructions, the instructions when executed by a computing system cause the computing system to perform operations comprising:
receiving a plurality of training images, the training images comprising a set of labeled training images and a set of unlabeled training images, wherein labels of the labeled training images are received from a client device of a user;
training an object detection model using the set of labeled training images;
applying one or more images of the set of unlabeled training images to the object detection model to generate a first output of the object detection model;
transmitting, to the client device, the first output of the object detection model;
receiving, from the client device, user feedback indicating accuracy of the first output of the object detection model;
updating the set of labeled training images by labeling one or more images of the set of unlabeled training images according to the user feedback; and
re-training the object detection model using the updated set of labeled training images.

2. The non-transitory computer-readable storage medium of claim 1, wherein re-training the object detection model using the updated set of labeled training images comprises re-training the object detection model responsive to the user feedback comprising a threshold number of user-provided object labels.

3. The non-transitory computer-readable storage medium of claim 1, wherein updating the set of labeled training images by labeling one or more images of the set of unlabeled training images according to the user feedback comprises labeling one or more images of the set of unlabeled training images with user-provided object labels.

4. The non-transitory computer-readable storage medium of claim 1, wherein updating the set of labeled training images by labeling one or more images of the set of unlabeled training images according to the user feedback comprises labeling one or more images of the set of unlabeled training images with the first output of the object detection model responsive to an indication by the user that the first output is correct.

5. The non-transitory computer-readable storage medium of claim 1, wherein the instructions further comprise instructions that when executed by the computing system cause the computing system to perform operations comprising:
applying one or more additional images of the set of unlabeled training images to the re-trained object detection model to generate a second output of the re-trained object detection model;
transmitting, to the client device, the second output of the re-trained object detection model;
receiving, from the client device, user feedback indicating accuracy of the second output of the re-trained object detection model;
updating the set of labeled training images by labeling the one or more additional images of the set of unlabeled training images according to the user feedback; and
re-training the re-trained object detection model using the updated set of labeled training images.

6. The non-transitory computer-readable storage medium of claim 5, wherein the instructions further comprise instructions that when executed by the computing system cause the computing system to perform operations comprising:
applying a first sample image of a sample image set to the object detection model to generate a third output of the object detection model prior to re-training;
applying the first sample image of the sample image set to the re-trained object detection model to generate a fourth output of the re-trained object detection model;
transmitting, to the client device, the third output of the object detection model and the fourth output of the re-trained object detection model;
receiving, from the client device, user feedback indicating accuracy of the fourth output of the re-trained object detection model relative to the third output of the object detection model; and
reverting the re-trained object detection model to an earlier training state responsive to user feedback indicating reduced accuracy of the fourth output of the re-trained object detection model,
wherein the sample image set comprises a plurality of images which are not used in training the object detection model.

7. The non-transitory computer-readable storage medium of claim 1, wherein the instructions further comprise instructions that when executed by the computing system cause the computing system to perform operations comprising:
repeating steps of applying, transmitting, receiving, updating, and re-training until each image of the plurality of training images have been labeled.

8. A method comprising:
receiving a plurality of training images, the training images comprising a set of labeled training images and a set of unlabeled training images;
training an object detection model using the set of labeled training images;
applying one or more images of the set of unlabeled training images to the object detection model to generate a first output of the object detection model;
transmitting the first output of the object detection model;
receiving user feedback indicating accuracy of the first output of the object detection model;
updating the set of labeled training images by labeling one or more images of the set of unlabeled training images according to the user feedback; and
re-training the object detection model using the updated set of labeled training images.

9. The method of claim 8, wherein re-training the object detection model using the updated set of labeled training images comprises:
receiving an indication by the user to initialize re-training of the object detection model; and
re-training the object detection model using the updated set of labeled training images responsive to the indication.

10. The method of claim 8, wherein re-training the object detection model using the updated set of labeled training images comprises:
adjusting a re-training interval based on a static interval and a quantity of user feedback received;
determining that the re-training interval has elapsed since the object detection model was last trained; and
re-training the object detection model using the updated set of labeled training images.

11. The method of claim 8, wherein re-training the object detection model using the updated set of labeled training images comprises:
determining, based on the user feedback, that an error threshold of the object detection model has been met; and
re-training the object detection model using the updated set of labeled training images responsive to meeting the error threshold.

12. The method of claim 11, wherein the error threshold of the object detection model comprises a percentage of outputs of the object detection model for which the user feedback comprises a corrective object label.

13. The method of claim 8, further comprising:
identifying a group of two or more images of the set of unlabeled training images having a high degree of similarity;
identifying a representative image of the group;
applying the representative image to the object detection model;
receiving user feedback indicating accuracy of a corresponding output of the object detection model, the user feedback comprising confirmation of the output; and
labeling each image of the group according to the output of the object detection model.

14. The method of claim 13, wherein the representative image of the group is classified as a high-value image for training the object detection model.

15. The method of claim 8, further comprising:
receiving, from an image sensor, the set of unlabeled training images;
transmitting, to a client device, the first output of the object detection model; and
sending for display, in a user interface of the client device, a notification alerting the user to provide feedback indicating accuracy of the first output.

16. The method of claim 8, wherein updating the set of labeled training images by labeling one or more images of the set of unlabeled training images according to the user feedback comprises:
updating a plurality of object labels according to the user feedback, wherein each object label of the plurality of object labels is associated with one or more images of the set of unlabeled training images.

17. The method of claim 15, further comprising:
calculating, for each image of the set of unlabeled training images, a similarity index;
identifying, based on similarity indices, a group of two or more unlabeled training images meeting a similarity threshold;
applying one image of the group of two or more unlabeled training images to the object detection model; and
updating an object label corresponding to the group of two or more unlabeled training images responsive to user feedback.

18. The method of claim 8, wherein training an object detection model using the set of labeled training images comprises:
determining a first set of weights associated with the set of labeled training images; and
training the object detection model using the first set of weights.

19. The method of claim 17, wherein re-training the object detection model using the updated set of labeled training images comprises:
determining a second set of weights associated with the updated set of labeled training images for which user feedback on the accuracy of the object detection model was received; and
re-training the object detection model using the second set of weights associated with the updated set of labeled training images.

20. A system comprising:
a set of processors; and
a non-transitory computer-readable storage medium comprising stored instructions, the instructions when executed by the set of processors cause the set of processors to perform operations comprising:
receiving a plurality of training images, the training images comprising a set of labeled training images and a set of unlabeled training images, wherein labels of the labeled training images are received from a client device of a user;
training an object detection model using the set of labeled training images;
applying one or more images of the set of unlabeled training images to the object detection model to generate a first output of the object detection model;
transmitting, to the client device, the first output of the object detection model;
receiving, from the client device, user feedback indicating accuracy of the first output of the object detection model;
updating the set of labeled training images by labeling one or more images of the set of unlabeled training images according to the user feedback; and
re-training the object detection model using the updated set of labeled training images.
